(19) United States
(12) Patent Application Publication
(10) Pub. No.: US 2016/0019628 A1
(43) Pub. Date: Jan. 21, 2016

(54) METHOD, SYSTEM, AND ARTICLE FOR FACILITATING ONLINE COMMERCE

(71) Applicant: My Virtual Mall, LLC, Vienna, VA (US)

(72) Inventors: Srinivas Udumudi, Hyderabad (IN); Sridhar Dhagam, Hyderabad (IN); Vinay Surabhi, Ashburn, VA (US)

(21) Appl. No.: 14/332,740

(22) Filed: Jul. 16, 2014

(51) Int. Cl. G06Q 30/06

(52) U.S. Cl. CPC G06Q 30/0633

(57) ABSTRACT

An exemplary method, system, and article for online commerce are provided. One exemplary embodiment can be a method for facilitating online commerce. The method may include navigating to an online mall website including a database, entering user data into the database, navigating to a merchant website of a plurality of merchant websites without cooperation from the plurality of merchant websites, viewing the merchant website with a browser instance, and opening a plurality of hidden browser instances to communicate information to and from the online mall website and the merchant website offering products for sale.

### FIELD

Generally, the present disclosure pertains to a method, system, and article for facilitating online commerce.

### BACKGROUND

Generally, retail shopping changed with the advent of online shopping, otherwise known as “e-commerce”, allowing customers to purchase goods and services over the internet. Initially, merchants dealt with many challenges, such as collecting product selections as well as shipping and payment information from the consumer. One solution is requiring customers to input shipping and billing addresses and credit card information as well as other personal information such as name, email address, and phone number into store website databases. Traditionally, these forms have been fairly lengthy and time consuming. Although many customers find this checkout process cumbersome, usually the convenience of shopping online outweighs the burden.

However, a simple, speedy checkout would be advantageous. Customers shopping online spend a lot of time entering shipping, billing and credit card data into forms at online merchant websites after purchase. Although online merchant websites provide features to save such data in their databases for future purchases, there are several drawbacks, such as first time shoppers having to create an account to enter all the data at the online store. Moreover, entering personal and credit card data at a large number of online merchant websites can create security risks.

One proposed solution is a site acting as an online store gateway for shopping that would complete on behalf of the user all the forms related to shipping, billing and ordering payment information for the products purchased at several visited merchant websites. Such a solution could also create accounts at the online merchant websites on the user's behalf by providing registration information.

Other existing solutions can provide a single website with access to multiple merchant websites, but collect total billing amounts directly from the customer and make payments to each vendor physically outside the system; provide a mechanism for each store vendor to maintain his own store within a framework defined at a single website; place orders with the vendors outside the system based on orders collected at a website that only maintains a catalog; place orders with the back end systems of vendors through systems integration with the aggregating website; and provide a single payment card data storage and processing mechanism, e.g., an electronic wallet, for storing a user's data, which can then be integrated with each store. Alternatively, a form completion tool may also be used.

However, these solutions suffer from slow performance and/or permissive integration with the store website. Particularly, as the user shops at multiple merchant websites, tasks are performed at each store independently. Performing the tasks serially can require too much process time reducing the benefit to the user in terms of time saved. Thus, generally there is a need for a solution to perform these tasks in a parallel fashion. Moreover, there is a desire to facilitate this ability of parallel processing on devices of individual users, as opposed to a central location.

### SUMMARY

One exemplary embodiment can be a method for facilitating online commerce. The method may include navigating to an online mall website including a database, entering user data into the database, navigating to a merchant website of a plurality of merchant websites without the cooperation from the plurality of merchant websites, viewing the merchant website with a browser instance, and opening a plurality of hidden browser instances to communicate information to and from the online mall website and the merchant website offering products for sale.

Another exemplary embodiment can be a system for online commerce. The system may include a data processing device that may be adapted to execute computer-readable instructions contained in a memory. The data processing device can be structured and arranged to provide a browser to a merchant website of a plurality of merchant websites at which a user can navigate to and through, provide at least one of a web page that may be separate from the merchant website and a web page provided at the merchant website, display purchase and product information extracted from the merchant website, provide a universal shopping cart at the merchant website that can be separate from a merchant shopping cart, store at least one product offered for sale at the merchant website, transact a single checkout transaction with the user, and maintain integration between an online mall website and the plurality of merchant websites by generating a plurality of hidden browser instances to communicate with a plurality of merchant websites.

A further exemplary embodiment may be an article of manufacture for completing a single checkout purchase transaction between an online user and a plurality of merchants. The article of manufacture can include a computer-readable program embedded thereon for completing the single checkout purchase transaction. Generally, the program includes instructions for providing an online mall website at which a user can navigate to and through at least one web page that may display purchase and product information extracted from any of the plurality of merchants without cooperation from the plurality of merchants. Additionally, the program can include providing a universal shopping cart on at least one merchant website for storing and managing without cooperation from any of the plurality of merchants at least one product offered for sale by any of the plurality of merchants, generating a plurality of hidden browser instances to establish communication between the online mall website and a plurality of merchant websites, and providing real time product information until a transaction session is completed.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a schematic depiction of one exemplary embodiment of a system for online commerce.

FIG. 2 is a block flow diagram of an exemplary mode of making the system for online commerce.

FIGS. 3-5 show an illustrative embodiment during various steps of making a purchase transaction.

FIGS. 6-13 are block flow diagrams of an exemplary mode of operation for administering an activity for one exemplary system.

### DEFINITIONS

In the detailed description and claims which follow, the terms “including” and “comprising” are used in an open-ended fashion, and thus should be interpreted to mean “including, but not limited to . . . ”.

As used herein, it should be understood that reference to a single device or site may also encompass multiple devices or sites, such as a data processing device may include at least one data processing device and an online mall website may include at least one online mall website.

As used herein, the term “browser instance” can refer to a step in browsing the internet that can be visible to a user and implemented with a web browser to provide a web interface between the viewed web page and the user.

As used herein, the term “hidden browser instance” may refer to a step in browsing hidden from a user and in parallel with a browser instance implemented with a web browser. A hidden browser may load information, such as product information, from a merchant website and communicate to an online mall website and vice-versa. The term “hidden browser instance” may be abbreviated “HBI” and “hidden browser instances” may be abbreviated “HBIs”.

As used herein, the term “module” or “extension” can refer to a computer program and may be downloadable to modify a web browser to provide a modified web browser.

As used herein, the term “task” can refer to an undertaking required to partially complete or complete an activity. A task may be the activity of a user using a browser instance or of the web browser using a hidden browser instance. Regarding the activity of the hidden browser instance, such activity can include facilitating communication between an online mall website and a plurality of merchant websites for logging into a website, modifying a virtual shopping cart, and checking out from online shopping.

As used herein, the term “product” can refer to a good or a service offered for sale by a merchant.

As used herein, the term “hypertext transfer protocol” can refer to an application for distributed, collaborative, hypermedia information systems and is typically the foundation of data communication for the World Wide Web, and may be abbreviated “HTTP”.

As used herein, the term “hypertext markup language” may refer to the standard markup language used to create web pages and may be abbreviated “HTML”.

As used herein, the term “uniform resource locator” can refer to a web address, particularly when used with HTTP, and may be a specific character string that constitutes a reference to a resource. Uniform resource locator may also be referred to as “universal resource locator”. In most web browsers, the uniform resource locator of a web page can be displayed on top inside an address bar and may be abbreviated as “URL”.

As used herein, the term “inventory” may refer to an itemized list or catalog of products. As an example, an inventory can store a listing of products, including their location, e.g., at a particular merchant website.

As used herein, the term “database” or “repository” can refer to a store of information, and can include a relational database, a directory service, or a flat file maintained on an electronic storage medium, e.g. hard drive, or another mechanism, e.g., a computer, work station, or terminal, that includes a device to access and manage the information.

### DETAILED DESCRIPTION

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

One exemplary embodiment of the present system and method may provide a web browser-based online shopping system. A data processing device, such as a computer or mobile device, can allow internet access utilizing a web browser. A user can access an online mall website to download a module or extension to modify the browser for providing additional functionality to modify, e.g., a computer and/or its operation. This added functionality can include modifying the web browser to launch a plurality of hidden browser instances to facilitate in parallel access to a plurality of merchant websites while a user has an interface with a website by using a browser instance. Generally, the universal shopping cart may serve as a pass-through gateway for passing data from a plurality of merchant websites to a user for purchasing products. Architecture can be provided to ease the adding of merchant websites to the online mall website.

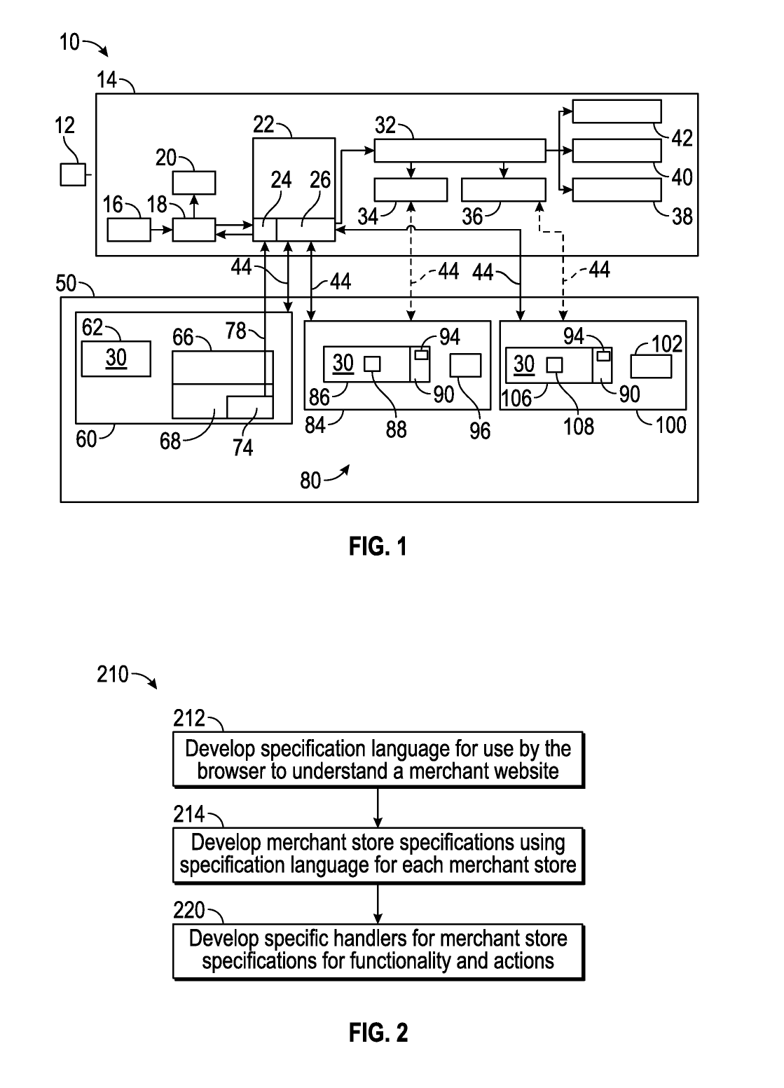

Referring to FIG. 1, an exemplary system 10 for online commerce can include a data processing device 14 having access to an internet 50 for use by a user 12, typically a person. Although the internet 50 is disclosed in this exemplary embodiment, it should be understood that any suitable communications network can be utilized. Such a communications network generally connects a client with a server, and in the case of peer-to-peer communications, connects two peers. The communication may take place via any media such as standard telephone lines, local area network (LAN) or wide area network (WAN) links, broadband connections, and wireless links. Preferably, the network can carry transmission control protocol (TCP) and internet protocol (IP) communications, and HTTP requests and hypertext transfer protocol secure (HTTPS) requests made by a web browser and the connection may be made between the peers and communicated over such TCP/IP networks.

The type of network is not a limitation, however, and any suitable network may be used. Non-limiting examples of networks that can serve as or be part of the communications network include a wireless or wired Ethernet-based intranet, a LAN or WAN, and/or the global communications network known as the internet, which may accommodate many different communications media and protocols. The computers implementing the embodiments herein may operate in a networked environment using logical connections to one or more remote computers, the remote computers typically including many or all of the elements described herein.

Various networks may be implemented in accordance with the embodiments of the invention, including a wired or wireless LAN and WAN, wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to a system bus via the consumer-input interface, or other appropriate mechanism. Computers may be connected over the internet, an intranet, extranet, ethernet, or any other system that provides communications. Some suitable communications protocols may include TCP/IP, user datagram protocol (UDP), or open systems interconnection protocol (OSI), for example. For wireless communications, communication protocols may include Bluetooth, Zigbee, IrDa or other suitable protocol. Furthermore, components of the system may communicate through a combination of wired or wireless paths.

The data processing device 14 may be implemented by a processor on a computing device, which may include embodiments such as a mobile platform, such as a hand-held wireless device, e.g., a mobile telephone, a cellular telephone, a smart phone, a personal data assistant, a computer tablet, a computer pad; or as a stationary platform, e.g., a network appliance, a personal computer, a workstation, a multiprocessor system, a minicomputer, a microprocessor-based or programmable consumer electronics, a mainframe, a networked client server, a server, and network equipment. The embodiments disclosed herein may also be practiced in distributed computing environments where tasks are performed by remote processing devices that are linked through a communications network, such as the internet 50. In a distributed computing environment, program modules may be located in both local and remote computer storage media including memory storage devices.

In one exemplary embodiment, the data processing device 14, such as a desktop computer, may include an input 16, a processor 18, an output 20, and a memory 22. Generally, a system bus couples various system components including the memory 22 to the processor 18. The processor 18 executing commands and instructions may be incorporated into a general or special purpose computer, but may utilize a wide variety of other technologies including a programmed micro-processor, a micro-controller, a peripheral integrated circuit element, a consumer specific integrated circuit (CSIC), an application specific integrated circuit (ASIC), a logic circuit, a digital signal processor, a programmable logic device such as a field programmable gate array (FPGA), a programmable logic device (PLD), a programmable logic array (PLA), a radio-frequency identification (RFID) integrated circuit, a smart chip, or any other device or arrangement of devices that are capable of implementing the steps of the processes of the embodiments disclosed herein. Often, the processor 18 includes a central processing unit (CPU).

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processor and/or memory may be composed of different physical pieces of equipment.

Typically, the input 16 includes a consumer interface of one or more of a keyboard, pointing device such as a mouse, graphic pad, track ball, touch pad, joystick, game pad, satellite dish, voice recognition device, toggle switch, push button, scanner, microphone, webcam, and touchscreen. The input 16 can also include a modem receiving instructions from other websites via their servers over the internet 50. These and other input devices are often connected to the processing unit through a consumer input interface that is coupled to the system bus, but may be connected by other interface and bus structures, such as a parallel port, game port or a universal serial bus (USB).

Generally, the output 20 includes one or more of a printer, monitor, display, projector, speaker, headphone, modem, tactile device, network card, WiFi card, and network card. One or more monitors or display devices may be connected to the system bus via an interface. In addition to display devices, computers may also include other peripheral output devices, which may be connected through an output peripheral interface. The memory 22 can include volatile and non-volatile memory. Volatile memory can include random access memory and graphic random access memory and non-volatile memory can include one or more of a floppy drive, read only memory (ROM), hard drive, compact disc (CD) drive, digital versatile disc (DVD) drive, and USB flash drive and optionally corresponding recording media.

The recording media may be removable or non-removable, and volatile or nonvolatile. For example, a hard disc drive may read or write to non-removable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state random-access memory (RAM), and solid state ROM. The storage media are typically connected to the system bus through a removable or non-removable memory interface. Such storage media can be considered an article of manufacture.

In one exemplary embodiment, the memory 22 may include a data store 24 on a hard drive storing various programs, such as basic input/output system (BIOS), an operating system, and one or more application software programs, such an internet web browsing program to provide a browser, a browser program, or a web browser 26. Usually, the BIOS contains the basic routines that help to transfer information between elements, such as during start-up, and is typically stored in ROM. RAM typically contains data and/or program modules that are immediately accessible to and/or presently being operated on by the processor 18. At a minimum, the memory 22 can include at least one set of instructions or code that may be either permanently or temporarily stored. Generally, the processor 18 executes the instructions that are stored in order to process data. The code may include various instructions that perform a particular task or tasks. Such a set of instructions or code for performing a particular task may be characterized as a program, software program, software, engine, module, extension, component, mechanism, or tool.

The system may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments. Illustratively, the programming language used may include assembly language, Ada, APL, Basic, C, C++, COBOL, dBase, Forth, FORTRAN, Java, Modula-2, Pascal, Prolog, RUM and/or JavaScript, for example. Further, any number of different programming languages may be utilized as is necessary or desirable in conjunction with the operation of the system and method of the embodiments disclosed herein.

The data or program modules may include an operating system, application programs, such as a web browsing program, other program modules, and program data. The operating system may be or include a variety of operating systems such as those sold under the trade designation MICROSOFT WINDOWS operating system sold by Microsoft Corporation of Redmond, Wash.; the UNIX operating system provided by The Open Group of Burlington Mass.; the LINUX operating system developed under the model of free and open source software development; the AIX operating system developed by IBM of Armonk, N.Y.; the UX operating system of Hewlett-Packard of Palo Alto, Calif.; the NETWARE operating system of Provo, Utah; and the SOLARIS operating system owned by Oracle Corporation of Redwood City, Calif.

Also, the instructions and/or data used in the practice of the invention may utilize any compression or encryption technique or algorithm, as may be desired. An encryption module might be used to encrypt data. Further, files or other data may be decrypted using a suitable decryption module.

Typically, an internet web browsing program can include a browser under the tradenames CHROME browser by Google Inc. of Mountain View, Calif.; INTERNET EXPLORER browser by Microsoft Corporation of Redmond, Wash.; the open source FIREFOX browser developed by the Mozilla Foundation of Mountain View, Calif.; the SAFARI browser developed by Apple Inc. of Cupertino, Calif.; and the OPERA browser developed by Opera Software ASA of Oslo, Norway. The memory 22 can include random-access memory and read-only memory, and the data store 24 can take various forms, such as a hard disk drive.

In these browsers, a module or extension 74, as hereinafter described, can be downloaded 78 to modify a browser to allow opening of additional windows or instances, and correspondingly to modify the data processing device 14, e.g., a computer, and/or its operation. These instances can be hidden from the user, and thus can be referred to as a hidden browser window or instance.

As browsers are developed by different organizations, the browsers are written in different languages and have different extensions that allow for added functionality. As an example, the FIREFOX browser is generally developed by an open source community and uses a language called XUL for the development of extensions designed as a plugin. INTERNET EXPLORER uses Browser Helper Object (BHO) that can be programmed on a platform called .NET framework using the programming languages C#, VB.Net, or J#. A tool such as Add-In Express can be utilized to create the BHO extension. CHROME extensions can be developed using the language JavaScript. As an example, language for adding a hidden browser instance to a FIREFOX browser can be as follows:

| <toolbar id=“BRS-Toolbar1” toolbarname=“” accesskey=“q” | |
|---|---|
| class=“chromeclass-toolbar” context=“toolbar-context- | |
| menu” hidden=“false” persist=“hidden collapsed” height=“0px” | |
| collapsed=“false”> | <browser id=‘myBrowser’ |

type=“content” src=“” flex=“1” hidden=“false” persist=“hidden”
height=“750px” />

The web browser 26 can communicate with the online mall website 60 in a language such as JSON, JSONP, or XML, preferably JSON, supported by Representational State Transfer (REST) architecture. The merchant specifications can be defined in a modified XML language with instructions to process merchant actions. In one exemplary embodiment, the merchant specification details are developed in JSON format and each browser can read this JSON specification and perform actions described in the specification against the merchant.

Usually, the browser program 26 has components, including a communicator, a render, a manager, and an observer. The communicator can have the functionality to communicate with the online mall website 60 to get the store specifications, handlers and user profile information based on the requirements. The render may be used for navigating the user 12 from one screen to another screen and link the observer to the monitor viewed by the user 12. The observer can be used for observing the user's actions at the merchant websites and notify the processor 18 to update the universal shopping cart 94 when the user 12 adds, updates, and/or deletes products from the universal shopping cart 94. The manager can regulate the hidden browser instances to identify the actions to be performed in the merchant stores, execute the steps in the specifications and retrieve handlers. As an example, the information can be read from the merchant website 84 and sent to the communicator to update the server 66 and the universal shopping cart 94 in the sidebar 90 as seen by user 12 at their display.

After modification, the web browser 26 can include the extension to provide a hidden browser instance (HBI) queue 32 creating any suitable number of hidden browser instances, such as a plurality of hidden browser instances 32, namely a first HBI 34, a second HBI 36, a third HBI 38, a fourth HBI 40, and a fifth HBI 42. As discussed herein, the terms “HBI queue 32” and “plurality of HBIs 32” may be used interchangeably. In this exemplary embodiment, five HBIs are provided, although in other embodiments a single HBI may be used, or more than five HBIs can be created and used.

Links 44 can allow the web browser 26 to communicate with the internet 50 either through a browser instance 30 or through the one or more of the hidden browser instances 34, 36, 38, 40, and 42, which can operate in parallel with respect to the browser instance 30. The modified browser may use a completely sandboxed location on the data store 24 of the data processing device 14 to, e.g., store its cookie jar, its URL history, and local and session storage. Product information may be extracted, and include, e.g., the item price, brand, available colors, a size listing, description information, product reviews, return policies, coupon codes, and product images.

The internet 50 can include the online mall website 60 having a web page 62, viewed in the browser instance 30, and communicating with a server 66, in turn having a database 68 housing the module or extension 74. The online mall website 60 can have URL links 44 to a plurality of merchant websites allowing the user 12 to serially navigate to, e.g., a first merchant website 84 and a second and another merchant website 100. Although two merchant websites are depicted, it should be understood that URL links to scores or hundreds of merchant websites can be provided at the online mall website 60. Typically, these links are pre-established and embedded at the web page 62 of the online mall website 60 for configuring with the merchant sites. Generally, the first merchant website 84 includes a web page 86, again viewed by the browser instance 30 at another moment in time, a discrete, merchant shopping cart 88, a sidebar 90, and a universal shopping cart 94. The first merchant website 84 can be hosted on a server 96. Typically, the second merchant website 100 includes a web page 106, again viewed by the browser instance 30 at still another moment in time, a second discrete, merchant shopping cart 108, the sidebar 90, and the universal shopping cart 94. The second merchant website 100 can be hosted on a server 102. The sidebar 90 and the universal shopping cart 94 can be created by the data processing device 14, such as by utilizing the web browser 26. So, the same sidebar 90 and the universal shopping cart 94 may be used at each merchant website 84 and 100 linked to the online mall website 60. Although the sidebar 90 and the universal shopping cart 94 are viewed by the user 12 while navigating to the plurality of merchant websites 80, the plurality of merchant websites 80 are not modified and the sidebar 90 and the universal shopping cart 94 are not part of any of the plurality of merchant websites 80. Rather, the data processing device 14 outputs the sidebar 90 and the universal shopping cart 94 to a display viewed by the user 12 as the user 12 browses each merchant website of the plurality of merchant websites 80. Thus, merchants are generally unaware of the sidebar 90 and the universal shopping cart 94.

Products can be identified by URLs on the participating merchant's website or through universal product identification numbers, thus allowing the system to locate the product quickly and simply using the URL. The acquisition of product information includes searching for products, e.g., on a supported merchant's website, using a product URL and/or a universal product identification number, such as a universal product code (UPC), an international article number (IAN), a Japanese article number (JAN), a global trade identification number (GTIN), or an internal, merchant-specific product number. Advantageously, the system 10 allows the user 12 to find a desired product simply using a URL, UPC, IAN, JAN, GTIN, or an internal, merchant-specific product number. Preferably, the user 12 can select products depicted on the display from the merchant website 84 for adding to the universal shopping cart 94.

In one exemplary embodiment, a mechanism can be provided whereby a queue of a fixed number of hidden browser instances, such as five, are initiated and maintained in the background hidden from a user. However, any suitable number of HBIs can be created, such as at least 2, 4, 6, 10, 20, 30, or even 100 HBIs. The HBI queue may retrieve and return a hidden browser instance that is free to the requesting browser 26 for the execution of any task. Once completed, the hidden browser instance may return to the back of the queue for implementing other tasks in parallel with the browser instance 30. This modification can effectively enable a browser to become multi-threaded even when such facility is not natively available.

Moreover, threads can be created and conducted in a parallel fashion. Managed usage in a queue technique may save time for the user 12. This solution of multi-threading with hidden browser instances is generally not supported in a web browser, although some browsers such as version 11 of INTERNET EXPLORER can support threading of windows, albeit not hidden. By creating a large number of hidden browser instances upfront and managing their usage through queuing techniques, faster parallel execution of independent web browser tasks can be obtained and thus save time for a user 12.

Specification language can be created to link the online mall website 60 with one or merchant sites. Development of the specification language can include identifying an initial set of merchant actions based on analysis of a small set of merchant websites; developing custom code for two merchant sites for the initial list of merchant actions; developing a draft version of framework and merchant website specification language for these merchant actions; breaking large and complex actions into smaller actions resulting in a larger number of less complex actions; analyzing a set of merchant websites based on the initial draft version of specification language and framework; and identifying the variance for each action of these initial merchant websites based on the draft version of specification language. Subsequent development can include drafting specification language of an initial set of about ten merchant websites using the draft framework and specification language; modifying specification language to handle minor and major variances and reduce the amount of custom code; performing variance analysis again based on the current version of the specification language and framework; implementing specification for the next set of merchant websites; repeating until actions are performed efficiently with sufficient comprehensive specification language; and completing specification with the latest version of the language and framework. Afterwards, custom handlers may be developed for merchant websites that the specification language is unable to accommodate initially.

Development of a generic merchant action framework can provide several benefits, namely, allow an interface with the merchant websites without any formal engagement with the merchant, cart aggregation services without any back end systems integration or logistics setup, and efficient addition of merchant websites into a list of merchant websites supported by the online mall website without spending tedious hours in developing merchant specific code. Thus, a very large number of merchant websites can be supported with quick turnaround. Additionally, any modifications made by the merchant websites can be quickly updated in the specification files without a major rewrite of the code. Thus, changes may be accomplished with faster turnaround at a lower expense.

Referring to FIGS. 1-2, one exemplary process 210 for creating an online architecture is depicted. Generally, the first step is developing specification language for use by the web browser 26 to understand a merchant website 84 at a block 212. Specification language is developed for each merchant represented by, e.g., icons, in a banner at the online mall website 60. Each merchant website can be analyzed with language developed for each website. The browser programs written for each browser 26 may perform the actions defined in this language. Next, merchant store specifications can be developed for the web browser 26 using unique specification language for each merchant website at a block 214. This specification may include the codes, such as date, city, state, country, and the like, to be used, details like support guest checkout, navigation URLs and steps to be performed for each action. The navigation URLs allow a user 12 to navigate to a merchant site, and as the user adds item to a cart, such additions may be monitored by an extension. In some instances, specification language is only used to navigate an HBI to a merchant site for performing actions on behalf of a user. The base code may be modified to address minor and major variations.

Regarding minor and major variances of the programming language among merchant sites, these variances can encompass many operational factors. Usually, the shopping process can be broken down into generic actions, such as registration, log on, add to cart, read cart, update cart, delete cart, shipping, billing, making payment, entering gift cards, entering promotional codes, entering shop cards, and adding shipping price. A classification mechanism can rate each merchant website with respect to complexity. A comparison of merchant sites allows collation of variations as minor or major.

Minor variations among merchant websites can include merchant registration, guest checkout, merchant log in, add to cart, edit cart, reading the merchant shopping cart for updating the online mall website, reading shipping and tax options for updating the online mall website, entering billing and shipping addresses, payment and place order options, order confirmation, and error messages. Examples of minor variations of registration include that some merchant websites only accept email as identification and password for registration, while other merchant websites require the details of first name, last name, and shipping address. Moreover, some merchant websites require credit card details at the time of registration. During guest checkout, some merchant websites do not allow users to add products to the shopping cart without registration, while other merchant websites allow the user to make purchases and make registration optional. Still other merchant websites provide options of guest checkout and log in to checkout. Concerning merchant log in, some merchant websites have email identification and password for log in, while other merchant websites have user identification and password, and still other merchant websites have email identification, password, and merchant and user category options. Regarding add to cart minor variances, many merchant websites have a button for a user to click to add to a cart, while other merchant websites have validations when clicking a button. Still other merchant websites require more details when adding products to a virtual cart.

Regarding editing a cart, merchant websites typically have different mechanisms. As an example, some merchant websites depict a drop down box for updating the quantity, while other merchant websites show a text box. Still other merchant websites provide a delete button and other merchant websites depict a remove link. Regarding reading a shopping cart, each merchant has its own HTML syntax for showing the cart products. As an example, some merchant websites show the products in an HTML table, while other merchant websites use HTML tags. Regarding shipping options and tax details, each merchant can have its own method of reading the shipping options. As an example, some merchant websites show the shipping options in the cart screen, while other merchant websites require a shipping address to be filled in to depict the shipping options and costs. In still other cases, merchant websites only require a zip code to show the shipping options. Regarding the entry of shipping address, each merchant can have different schemes for entering the shipping address. As an example, some merchant websites default the shipping address from the user profile and provide the option to update, while other merchant websites default the shipping address from a previous purchase and provide the option to update. Still other merchant websites may query the user to enter the shipping address. Regarding entering the billing address, each merchant may have different procedures for entering the billing address details. As an example, many merchant websites have the shipping address default into the billing address and provide the option to update, while other merchant websites default the billing address from a previous purchase. Still other merchant websites depict the billing address with payment options. Regarding payment options, some merchant websites allow the user options to select the card type, while other merchant websites depict the card type based on the card number entered by the user. Still other merchant websites can have text boxes for entering card expiry date and year compared to other merchant websites that have drop down controls. Regarding order details, some merchant websites depict the order confirmation screen before making final purchase, while other merchant websites initiate the purchase process as soon as payment details are entered. In regard to the order confirmation, some merchant websites show the order confirmation number in a separate page, while other merchant websites show the confirmation number in a pop-up dialog box. Regarding error messages, some merchant websites show the error messages at the top of the screen, while other merchant websites highlight the errors and depict a message. Still other merchant websites depict the error message in a pop-up dialog box. Thus, all these differences can constitute minor variations among merchant websites.

Major variations can include merchant registration, discount pricing, estimated tax reading, grouped shipping, shipping details, dynamic visibility screens, delay time implementation, handling of stacked merchant websites, calling custom handlers from an extension, and first and second time checkouts. As an example, many merchant websites in the merchant registration page provide options to select the countries, states, and date field drop down menus, while other merchant websites use codes for countries and/or state. These codes can vary from merchant-to-merchant. All codes need to be understood by the online mall website to correctly fill out forms at the merchant site. As an example, the actual price can be struck and a discounted price depicted in another location at the merchant website. The discounted price can be depicted at the online mall website. Regarding estimated tax reading, the estimated tax may be shown on the payment screen or after the payment details screen. Pertaining to grouped shipping, some merchant websites depict the cart products as groups and for each group depict the shipping options and shipping cost. When filling in the shipping details, keys may be pressed to initiate events. Regarding dynamic visibility screens, some merchant websites depict the shipping address and/or payment options dynamically on the screen using any suitable technology, such as AJAX technology or JavaScript technology. In the event of delay time implementation, after entering the shipping address details, the next screen can be displayed after a delay as the site processes address verification internally before showing the subsequent screen. Generally, an HBI can wait for a configured amount of time for the response to read the error message or identify the next steps. Regarding merchant stacking, some merchant sites organize multiple merchant brands with a common merchant cart with a single checkout. A browser may be modified to handle this type of merchant architecture. Code can be written to address particular screens for complicated merchant screens. Regarding first and second time checkouts, while making purchases in some merchant websites, if the purchase is a second purchase for the user, the merchant can default the shipping address details from the previous purchase. Updated specifications check for the types of controls and perform different steps. As an example, if the address details are depicted in the screen, the browser extension should edit the address to fill in the address selected in the online mall website 60. Thus, these differences can constitute major variations.

Specific handlers for merchant store specifications can be developed for functionality and actions at a block 220. This may be required only if the merchant website 84 has implementation that is unique and cannot be included in the specification language. Usually, handlers are needed only if there are major variations, but may be used to address minor variances as well.

Custom handlers may be made late in the programming process and can address shipping options, such as address fields; checkout options, such as complex checkout screens, frame controls, membership number handling, gift cards, handling of order numbers, address verification, call implementation; and unique log in pages. Regarding shipping options, some merchant websites depict the shipping options for each product in the cart, and the online mall website can read the options and depict the same options in the online mall website. For the shipping address fields, the shipping address can be entered for each item in the merchant cart. When the user updates the shipping address at the online mall website checkout screen, the browser can edit the shipping address for all the products in the merchant checkout screen inside the hidden browser instance. At checkout, some merchant websites utilize an electronic wallet service, such as PayPal. Thus, the HBI can select the option and enter the user's identification and password details for completing checkout. Regarding checkout screens, some merchant websites may have a single page with all the checkout details, but most of the sections are hidden and are made visible based on the user actions on the screen. In this case, it is difficult to identify which section is visible to the user and which section is hidden from the user and custom handlers are written to accommodate this difficulty. Regarding the frame controls, if the merchant website has frame controls, the custom handler may identify the controls within the frame to perform the requisite actions. For membership number handling, some merchant websites can have a membership number and entering this number can obtain special discounts. The updated online mall website can save the membership number and fill in the number at the appropriate merchant at the time of checkout. For gift cards, a user can enter the gift card number in the online mall website checkout screen and an HBI can use this number to fill the same in the merchant website gift card fields. In regard to reading the correct order number form, in some merchant websites the order number is located among paragraph text. A custom handler may parse the complete paragraph text and read only the order number, which may be matched with the purchase. For address verification, the selection of the correct address may be complicated if the merchant shows the previously entered address details in a dropdown. In such an instance, a custom handler can check for the correct address selection and if the correct address is not found, add a new address. Regarding call implementation, a zip code may be entered to populate state and city fields. A custom handler can be provided to fill the zip code details, wait for a few seconds, check for the city and state details, and continue on with the next actions. Regarding the log in page, some merchant websites can have two different screens with different HTML and any one of the two screens may be shown randomly. Custom handlers can be written to check which page is loaded and, based on the page loaded, fill the log in details. Thus, this summarizes the custom handlers.

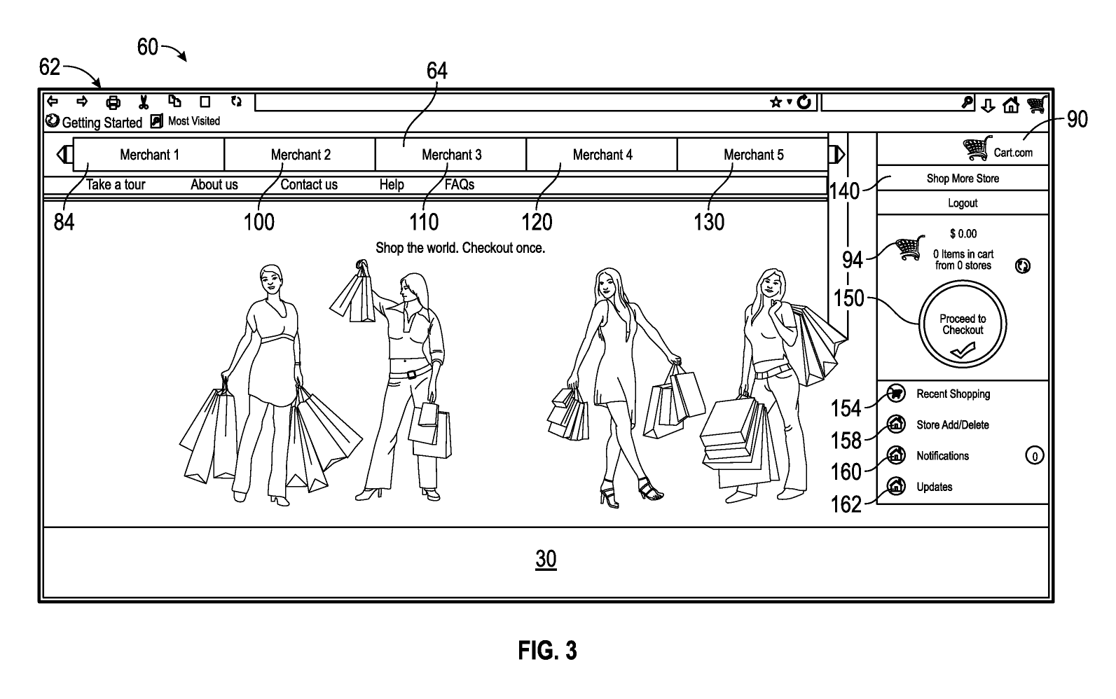

FIGS. 3-5 show an illustrative embodiment during various steps of making a purchase transaction using the system. As depicted in FIG. 3, one exemplary embodiment of an online mall website 60 having a webpage 62 is shown, as viewed at an interface by a user 12 using a browser instance 30. A banner 64 at the top of the online mall website 60 can provide links to a first merchant website (or Merchant 1) 84, a second merchant website (or Merchant 2) 100, a third merchant website (or Merchant 3) 110, a fourth merchant website (or Merchant 4) 120, and a fifth merchant website (or Merchant 5) 130. Optionally, favorite merchant stores may be marked by an asterisk and the banner 64 may depict only favorite stores by selecting an option to show only favorite stores.

Alternatively, the banner 64 can be organized by category, such as books, furniture, food, hardware, clothes, and so forth, of products sold. A user clicking on one of the links can navigate to the website of the indicated merchant. The online mall website 60 also may provide a sidebar 90, which in turn provides a button 140 to a plurality of merchant websites; a button 150 facilitating checkout; a button 154 to provide a list of recent shopping purchase merchant websites, products, prices, and order numbers; a button 158 for modifying merchant selection at the online mall website 60; a button 160 for notifications from the online mall website 60 administrator; and a button 162 for updating the user profile, shipping profile, billing profile and security profile. The user profile can include e.g., name, billing address, shipping address, telephone number, email address, and payment information. Clicking the button 140 can provide the banner 64 listing several merchant websites. The button 158 may allow the user to add, delete, and suggest merchant websites accessible at the top of the page via the banner 64. Generally, the sidebar 90 includes a universal shopping cart 94 for adding products from a plurality of merchant websites.

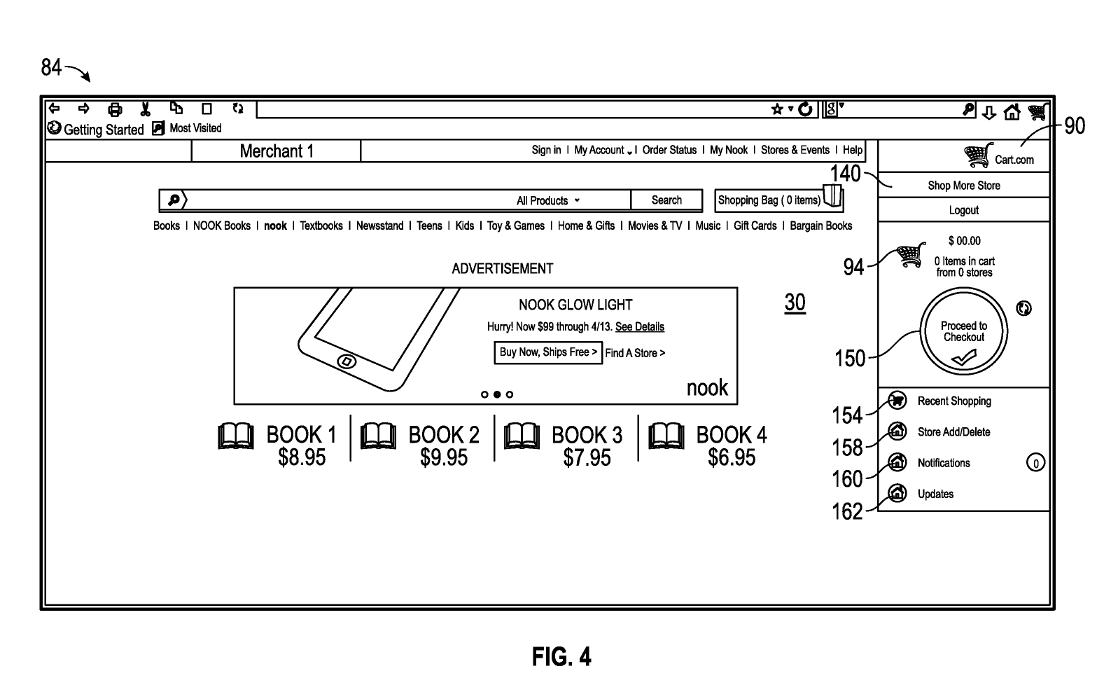

Referring to FIGS. 3-4, clicking the link to the merchant website 84 in the banner 64 can allow a user in this browser instance 30 to access the merchant website 84 to shop for one or more products at the merchant website 84. The sidebar 90, originally appearing at the online mall website 60, can be viewed at the merchant website 84. Generally, selected products at the merchant website 84 may be added to the universal shopping cart 94 of the sidebar 90. Typically, the user may select additional merchant websites by selecting the button 140 to shop at more merchant websites, with selected products being added to the inventory in the universal shopping cart 94. Alternatively, the user may select the button 150 for proceeding to checkout. In this exemplary embodiment, a user can select the button 140, shop at another merchant, before proceeding to checkout by selecting the button 150. By selecting the checkout button 150, the user can be transported back to the online mall website 60.

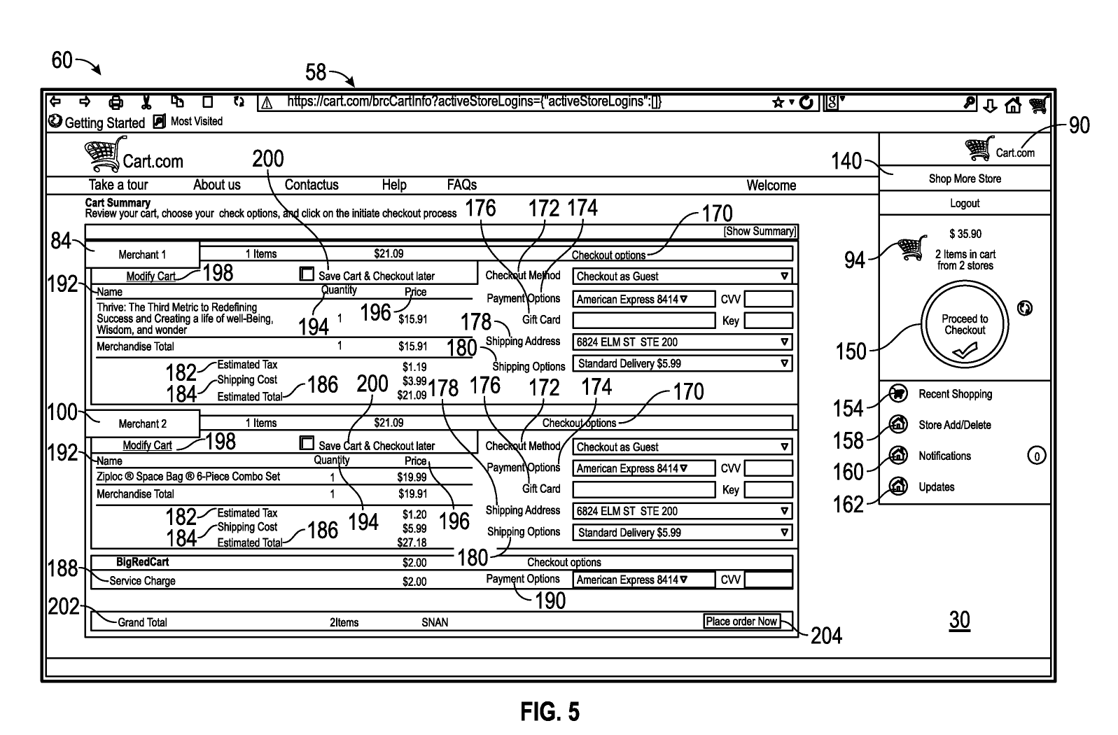

Referring to FIG. 5, another page at the online mall website 60 can provide a checkout screen 58. The checkout screen 58 can provide information from the first merchant website 84 and the second merchant website 100 regarding selections made by a user. Typically, checkout options 170 are provided for each Merchant 1 and 2. Although two merchants are depicted, it should be understood that more than two merchants can be populated at the checkout screen 58 and checked out. For each merchant, the fields are provided for selection by a user, namely, a checkout method 172, payment options 174, a gift card 176 and associated key field, a shipping address 178, and shipping options 180. Optionally, promotional fields may also be provided for each merchant for inputting an alpha numeric code, such as BIG25 or 4DADS, provided by a merchant to give a discount on product(s) purchased. Each product can be depicted by name 192, quantity 194, and price 196 and additional fields for an estimated tax 182, a shipping cost 184, and an estimated total 186 for each merchant. Each merchant summary may also provide a button 198 to independently modify a cart along with a checkbox 200 to save the cart and checkout later. The summary of the universal shopping cart 94 can provide a service charge 188, and total payment options 190. The summary of the universal shopping cart 94 may also provide a grand total 202 and a “Place Order Now” button 204. Placing the order allows the system to make the purchases on behalf of the user at the websites of Merchant 1 and Merchant 2, as well as initiate shipment of products to the user.

Referring to FIGS. 1 and 3-5, a hidden browser instance can perform several activities to facilitate, such as: log in, update inventory, modify cart, checkout, update extension, and online mall website payment. The descriptions that follow provide details on these activities in one exemplary embodiment yet are not limiting to the tasks performed by the hidden browser instances.

Regarding the sidebar 90, if the user 12 is browsing merchant websites configured to the online mall website 60, a hidden browser instance 34 can show the sidebar 90. Otherwise, the sidebar 90 may be hidden. Regarding log in, when the user 12 is browsing a merchant website 84 configured to the online mall website 60, the system 10 can check to verify if the user 12 has entered the merchant website credentials at the online mall website 60. If so, an HBI 34 can retrieve the credentials from the database 68 of the online mall website 60, navigate to the log on page of the merchant website 84, and provide the credentials to log in the user 12 at the merchant website 84. Regarding updating inventory, when the user 12 visits a merchant website 84 with a browser instance 30, the system 10 can check for the merchant website 84 credentials at the database 68 if the user 12 is logged into the online mall website 60. By default the credentials stored at the online mall website 60 may be used for the merchant website 84 when registering. Unless the user 12 has already registered and thus has different credentials to log in to merchant website 84, these credentials are stored and subsequently used.

If credentials are available, an HBI 34 can log the user 12 at the merchant website 84; if not, the system 10 may navigate to the merchant cart screen, read the merchant cart content, and update the database 68 at the online mall website 60. Also, once the user 12 logs into the online mall website 60, the browser instance 30 can check if the user 12 has any items in any merchant website 84 saved and not purchased, such as purchases made either as a merchant website log in user or guest user. If so, an HBI 34 can browse each of these merchant websites 84 and 100 to check the accuracy of the products in inventory and update the database 68 of inventoried products for purchase as well as the universal shopping cart 94 in the sidebar 90 as seen by the user 12.

Regarding modifying the cart, when the user 12 makes a purchase at a merchant website 84 configured to the online mall website 60, the web browser 26 observes the user's actions at the merchant website 84. When the user 12 clicks on the, e.g., “Add To Cart” button at the merchant website 84, the web browser 26 may use one of the HBIs to navigate to the cart screen at the merchant website 84, read the products in the merchant cart 88 and associated details, and update the database 68 and universal shopping cart 94 in the sidebar 90 via the web browser 26 as seen by the user 12. Generally, the cart page is not cached in the HBI 34 and typically selected products are added to the merchant shopping cart 88 at the merchant website 84 before loaded in the HBI 34. Moreover, when the user 12 makes a purchase at a merchant website 84 configured to the online mall website 60, the web browser 26 may observe the user's action on the merchant website 84. When the user 12 clicks on e.g., “Update” or “Remove Item” from the merchant website 84, the web browser 26 may use one of the HBIs to read the latest merchant shopping cart 88 from the merchant website 84 and update the merchant cart details at the database 68 and the universal shopping cart 94 at the sidebar 90 seen by the user 12.

Regarding checkout, if the user 12 purchases from more than five merchant websites and closes the web browser 26, the next log on to the online mall website 60 can result in the HBI queue 32 launching five HBIs, namely the first HBI 34, the second HBI 36, the third HBI 38, the fourth HBI 40, and the fifth HBI 42. The web browser 26 may create a stack of merchant websites in the HBI queue 32, use the five HBIs for the first five websites from the stack and navigate to the one merchant website in each HBI in parallel. These five HBIs can check the accuracy of the product inventory at the five merchant websites, and as soon as one HBI is free, the HBI queue 32 takes the next merchant website in the queue and uses a free HBI to check for the accuracy of the product inventory by checking the product inventory at the corresponding merchant website. If the user 12 navigates to a checkout screen 58 of the online mall website 60, and purchases are made from less than six merchants, the web browser 26 can use the five HBIs to navigate to each of the configured merchant websites. Once the following activities are completed in the merchant website 84, the HBI 34 may access the next merchant website 100 from the stack to perform several tasks.

The first task is to check if the credentials of a merchant website 84 are stored in the database 68. If so, the HBI 34 can log into that merchant website 84. If a log in fails, an error message is shown to the user 12 and the HBI 34 may proceed to the next merchant website 100, if available. If no merchant website log in details are available, the next tasks are performed as a guest user. If the HBI 34 finds the user 12 already logged into the merchant website 84 and the merchant credentials are stored at the data store 24, the HBI 34 can log out the user 12 from the merchant website 84 and then relog in with the credentials retrieved from the data store 24. The HBI 34 may read the merchant shopping cart 88 from the merchant website 84 and update the merchant website cart 88, as well as update the data store 24 and the universal shopping cart 94 in the sidebar 90 via the web browser 26. Subsequently, based on the merchant website checkout page design, the HBI 34 may complete the details, such as shipping address, billing address, payment details and read all the shipping options available for the merchant website 84 and populate the details in the checkout screen 58. The web browser 26 can read the tax on the product(s), discount details from the merchant website 84, and show the same details to the user 12 at the checkout screen 58. Some merchant websites do not allow a guest to checkout and require registration at the merchant website 84 for showing the shipping details or billing details. If the online mall website 60 does not store the merchant website credentials, the online mall website 60 can provide a screen to the user 12 to complete the registration at the merchant website 84 and store the merchant log on credentials in the database 68.

At the checkout screen 58, different fields for a merchant can be changed by the user 12. The shipping address for each merchant website can be changed. When the shipping address is changed, the web browser 26 can use one of the HBIs to navigate to the respective merchant website checkout screen and update the shipping details. Also, the applied credit card for each merchant website can be updated. When the credit card is updated, the web browser 26 can use one of the HBIs to navigate to the respective merchant website checkout screen and update the billing details. The user 12 may also choose the type of checkout as either a guest or as a registered merchant website user. If the merchant website allows guest checkout and the merchant credentials are stored in the database 68, the user 12 can choose to checkout as a guest. When the user 12 checkouts as a guest, then the web browser 26 can use hidden browser instances to log out the user 12 from the merchant website and navigate to the checkout screen 58. After changing these fields, an HBI may read the shipping options, and tax and/or discount details from the merchant website 84, and update the checkout screen 58 that is visible to the user 12.

Additionally, some merchant websites provide shipping options with different shipping costs for each product. The web browser 26 can read the shipping options for each product and show this information to the user 12 in the visible checkout screen 58. Moreover, after the user 12 updates all the details in the checkout screen 58 for all the merchant websites selected and enters the credit card code, e.g., “CVV” payment, the user 12 clicks on the “Place Order Now” button 204 as displayed in FIG. 5. The web browser 26 may perform the checkout process at each of the merchant websites using five hidden browser instances with the shipping and billing details opted by the user 12. If there are any error messages with a particular merchant website during checkout, the web browser 26 can read the error message and show the message to the user 12 indicating the merchant website. If the purchase is a success, then the purchase order number details are displayed to the user 12 and the details are also saved at the database 68. Generally, the purchase can be processed at the merchant website and the corresponding merchant ships the product to the user 12. With respect to the merchant and their website, the transaction proceeds as with any other individual shopper.

Regarding updating an extension, once the user 12 logs on to the online mall website 60, the web browser 26 can check to see if a newer version of the extension 74 exists. If a newer extension version is available, the newer extension 74 is installed and the web browser 26 is restarted to initiate the operation of the new version. In some browsers, the restart is done manually. Regarding online mall website payment, each successful merchant website checkout can initiate an HBI retrieving a fixed charged amount from the database 68 using the selected credit card.

Referring again to FIGS. 1 and 3-5, another exemplary method for facilitating online commerce is described. It should be understood that although a specific embodiment is described, other elements may be utilized as described above. The method can include the user 12 initiating an input 16, such as clicking a mouse, moving a track pad, speaking into a microphone, or typing on a keyboard, to open the web browser 26 depicted as an icon on a monitor or display. The processor 18 can execute instructions stored in memory 12 of the web browser 26 to activate the browser program 26. Once the browser program 26 is outputted to provide a display on the monitor, the user 12 may input a URL to navigate over the internet 50 to the online mall website 60 having a server 66 hosting the database 68. Once complete, the online mall website 60 can respond with a signal via the modem and provide a display on the monitor of the online mall website 60 for viewing by the user 12. Thus the data processing device 14 and online mall website 60 can establish a sessionless request and response communication over the internet 50. The user 12 using a mouse can output a signal transmitted over the internet 50 to the server 66 of the online mall website 60 for selecting web pages from the online mall website 60. Once the proper web page is selected, a signal from the online mall website 60 can be transmitted over the internet 50 to be received at the input 16 of the data processing device 14. The processor 18 can output the signal to a display for viewing by the user 12. Once depicted, the user 12 using a keyboard can input their data, which is processed and outputted over the internet 50 and stored in the database 68 of the online mall website 60.

Optionally, the user 12 can navigate to a web page at the online mall website 60 by communicating with its server 66. The web page can be depicted on the monitor. The user 12 can click on the mouse to send an output via the modem over the internet 50 to the server 66 at the online mall website 60 to download the extension 74 for modifying the web browser 26 for generating the plurality of HBIs 32 to facilitate communication between the online mall website 60 and the plurality of merchant websites 80 in parallel over the internet 50. In this instance, information can be communicated from the plurality of merchant websites 80, over the internet 50, received via the modem, cached in RAM, and outputted via the modem over the internet 50 to the online mall website 60, and vice-versa. Preferably, the plurality of HBIs 32 operates in a background and is not visible to the user 12 on the monitor, and more preferably, a hidden browser instance queue of up to five HBIs is created for communicating with the plurality of merchant websites 80 in parallel.

Next, the user 12 can click on an icon in the banner 64 of the first merchant website 84 by using a mouse while viewing the display and the web browser 26 can navigate the embedded URL of that merchant website 84 over the internet 50 to communicate with the server 96 of the first merchant website 84. The first merchant website 84 can send a signal over the internet 50 received at the input 16, transmitted to the processor 18, and outputted to display a webpage of the first merchant website 84 for viewing by the user 12. The server 96 may have relational (or other structured) databases to provide functionality, for example, as a database management system for merchant website data related to the services and consumers utilizing the service. Examples of databases include the MySQL Database Server or ORACLE Database Server offered by ORACLE Corp. of Redwood Shores, Calif.; the PostgreSQL Database Server by the PostgreSQL Global Development Group of Berkeley, Calif.; or the DB2 Database Server offered by IBM of Armonk, N.Y.

The merchant website 84 can be one of a plurality of merchant websites 80 displayed on the monitor for viewing by the user 12 via a browser instance 30. Moreover, the data processing device 14 and the online mall website 60 may establish another sessionless request and response communication link 44 over the internet 50. The user 12 through a series of inputs, such as clicking a mouse, can send instructions over the internet 50 to navigate through pages of the merchant website 84. The processor 18 executing code for the web browser 26 from the memory 22 can open a plurality of HBIs 32 to communicate information to and from the online mall website 60 and the merchant website 84 offering products for sale via the internet 50. Usually, the information communicated via the web browser 26 is from the merchant website 84 to the online mall website 60 including product information viewed on the monitor and selected by the user 12 via the mouse. In one circumstance, the information communicated from the online mall website 60 to the merchant website 84 may be credentials for logging into the merchant website 84, which can be retrieved by the web browser 26 from the database 68 of the server 66 of the merchant website 84. Alternatively the web browser 26 may store the credentials in a cookie to be provided to the server of the merchant website 84 over the internet 50.

Additionally, the web browser 26 can receive instructions from the memory 22 for generating a sidebar 90 on the monitor for viewing by the user 12. The sidebar 90 can depict the universal shopping cart 94 on the monitor while viewing the merchant website 84. Moreover, the user 12 can click a mouse to select a product at the merchant website 84 so that the web browser 26 may communicate over the internet 50 the product information to the database 68 at the online mall website 60 and update the universal shopping cart 94 with the product information to be displayed on the monitor for the user 12. What is more, the web browser 26 can maintain integration by facilitating communication over the internet 50 to update an inventory of a universal shopping cart 94 displayed on the monitor of the user 12 and each merchant shopping cart, and optionally further include maintaining integration for sending over the internet 50 product information as to shipping options and tax to the database 68 hosted by the server 66 of the online mall website 60.

A further exemplary embodiment may be a system 10 for online commerce. The system 10 can include a data processing device 14 that is adapted to execute computer-readable instructions contained in the memory 22. Usually, the data processing device 14 is structured and arranged to provide a web browser 26 communicating via a modem over the internet 50 to a merchant website 84 of a plurality of merchant websites 80. The user 12 can navigate to and through the internet 50 to at least one of a web page that is separate from the merchant website 84, such as the online mall website 60, and a web page provided at the merchant website 84. At the merchant website 84, the server 96 can transmit information over the internet 50 to be received at the input 16 and processor 18 for display via the output 20 to the user 12. The purchase and product information can be displayed on a monitor of the user 12 and extracted from the merchant website 84 by inputting instructions via, e.g., a mouse and/or keyboard and outputted via the modem over the internet 50 to the merchant website 84. While viewing the merchant website 84, the processor 18 can execute code for the web browser 26 from memory 22 to display a universal shopping cart 94 in a sidebar 90 on the monitor while viewing the merchant website 84 that is separate from the merchant shopping cart 88. The system 10 can store at least one product offered for sale at the merchant website 84. Particularly, a user 12 can input a selection via the mouse, which can then be processed as an output via a modem over the internet 50 to the merchant website 84. The communication can be received at a server at the merchant website 84 for transacting a single checkout transaction with the user 12. The web browser 26 may generate a plurality of hidden browser instances 32 to communicate with the plurality of merchant websites 80, and maintain integration between an online mall website 60 and the plurality of merchant websites 80.

What is more, the system 10 can be further adapted to maintain integration with a discrete, merchant shopping cart 88 for each merchant website 84 having at least one product contained in the universal shopping cart 94. This information can be communicated via the internet 50 through the web browser 26 from the plurality of merchant websites 80 and the online mall website 60 via the links 44, and vice-versa. These links 44 may be maintained by a sessionless request and response, via HTTP, over the internet 50. Integration can be maintained by the processor 18 executing instructions in memory 22 by generating up to five hidden browser instances 32 outputted via the modem to communicate with up to five respective merchant websites. The system 10 may further provide an inventory of products that have been added at any time to any of the merchant shopping carts to the universal shopping cart 94 in the online mall website 60. Particularly, the processor 18 executing code in memory 22 of the browser program 26 can generate an HBI 34 or HBIs outputted via the modem over the internet 50 to communicate with a server 96 of the merchant website 84. A product can be selected by the user 12 viewing a product on the monitor by clicking a mouse. The selection is processed and outputted over the internet 50 to communicate with the server 96 of the merchant website 84. Typically, the online mall website 60 further includes the server 66, which in turn includes the database 68 for providing the extension 74 communicated to the web browser 26 via the internet 50. The extension 74 can be transmitted when a user 12 selects, by clicking a mouse when viewing a display, to add the extension 74 to the web browser 26 for providing the plurality of hidden browser instances 32. Additionally, the web browser 26 can maintain integration with discrete merchants by the methodology described above, transact the single checkout transaction with the user 12, and in response to instructions from the user 12, and complete a purchase transaction with each discrete merchant by utilizing the plurality of the HBIs. Furthermore, the web browser 26 may be adapted to transfer information between the online mall website 60 and the plurality of merchant websites 80 by launching up to five HBIs. Generally, the HBIs are not visible to a user 12 on a display.

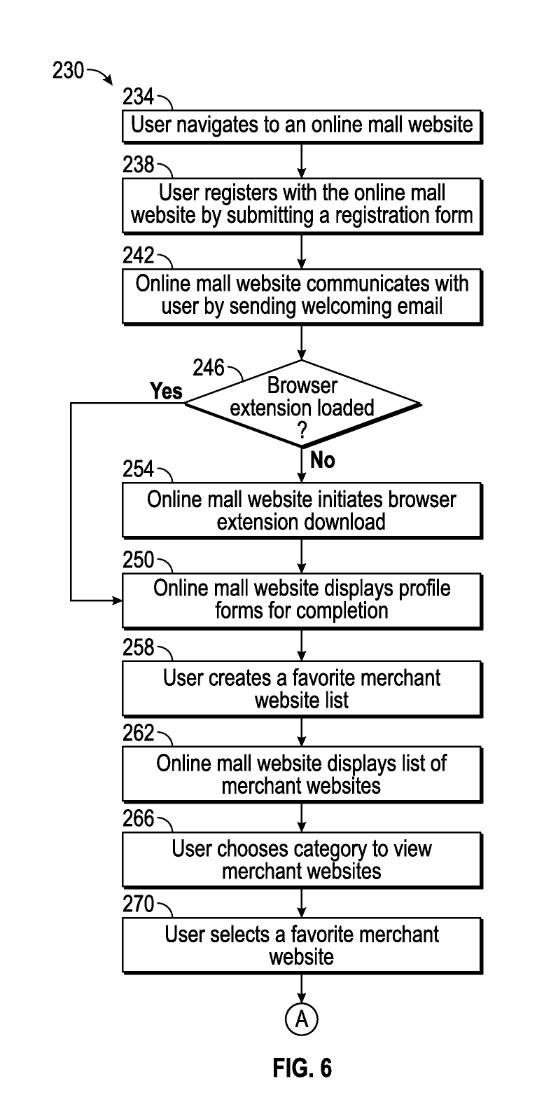

Referring to FIGS. 6-14, a mode of operation 230 for administering an activity for one exemplary system is depicted. Overall, the mode of operation 230 can include registration of a new user at the online mall website, downloading the browser extension, completing the user profile, selecting preferred merchant websites, logging into the online mall website, refreshing the universal shopping cart, shopping at the merchant websites, proceeding to checkout, modifying the universal shopping cart, checking out, changing attributes of a user, such as shipping address and payment card, and placing an order.

Referring to FIG. 6, one exemplary mode of operation 230 of the system 10 can include a user navigating to an online mall website at a block 234, and registering with the online mall website by submitting a registration form at a block 238. The registration form can include fields such as first and last name, email address, password, zip code, gender, and date of birth to be completed by a user with the option of shopping now and completing the forms later. The user can also read the terms and conditions of the online mall website. Furthermore, failure to accept terms and conditions can deny access to the online mall website. Additionally, the user can enter a log in identification and password to log in to the online mall website, and the user can log in to the online mall website after establishing credentials and be locked out if, e.g., wrong credentials are entered, such as more than five times. Next, the online mall website can communicate with the user by sending a welcome message, such as an email at a block 242. Once complete, a query can be made, namely, whether a browser extension is loaded at a diamond 246. If yes, the online mall website may display profile forms for completion by the user at a block 250. These profile forms may include shipping, billing, and security profile information of the user. If not, the online mall website can initiate the download of the browser extension at a block 254 before proceeding to the block 250. The browser extension may be in different languages depending on the type of browser utilized by the user. The browser extension can modify the browser to add an extension enabling, e.g., a sidebar for shopping, loading and enabling the user merchant list at the top of the webpage as a banner, loading the current shopping summary in the sidebar, displaying notification alerts in the sidebar, and optionally displaying advertisements. Additionally, the system can install a cookie in the user's browser to enable the browser extension to automatically log in when the browser restarts after the download and installation completes. Typically, the user restarts the browser after downloading the extension. Afterwards, the mode of operation 230 can return the user to the online mall website shopping page for completing profile forms. The user may create a favorite merchant list at a block 258 and then the online mall website can display a list of merchant websites at a block 262. Merchant sites may be categorized by types of products. Other options may also be presented to the user at the online mall website, optionally selected by the user, and shown by the online mall website. The user may select menu options to, e.g., take a tour of the online mall website, learn about the online mall website, contact the online mall website, help regarding the online mall website, list frequently asked questions, recent shopping conducted, notify the operator of the online mall website, and update the browsing software. What is more, the user can select merchant store and mark and/or unmark a store as preferred. If credentials are valid, such can be saved on the online mall website. Once complete, the user can choose a category to view the applicable merchant websites at a block 266 and optionally select a favorite merchant at a block 270 before proceeding to point “A”.

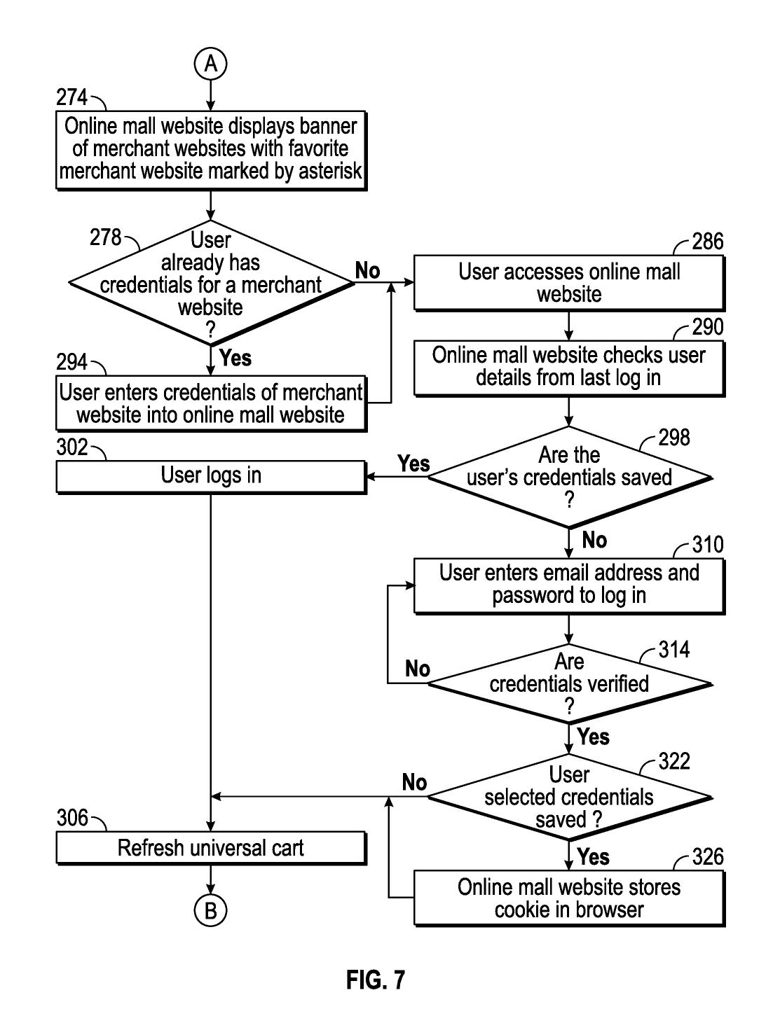

Referring to FIG. 7, from the point “A”, the online mall website may display a banner of merchant websites providing a link to the merchant's website and the favorite merchant marked by an asterisk at a block 274 prior to a query at a diamond 278. The query at the diamond 278 can ascertain whether a user already has credentials at a particular merchant's website. Generally, credentials include a user's log on and password for the merchant website. The user can enter the merchant store log in credentials and other details such as membership number. If “yes”, the user can enter the credentials into the merchant's website at the screen of “Store Add/Delete” or “Proceed to Checkout”, as hereinafter described, at a block 294, and then may proceed to a block 286. If the query at the diamond 278 is “no”, the typical operation is allowing the user to access the online mall website at a block 286, and then the online mall website may check user details from the last log in at a block 290. Afterwards, a query is made at a diamond 298, namely, are the merchant credentials saved? If “yes”, the user may log in at a block 302 and then the universal shopping cart can be refreshed at a block 306. If “no”, the user generally enters their credentials, e.g., email address and password, to log in at the merchant site typically at the screen of “Store Add/Delete” or “Proceed to Checkout”, as hereinafter described, at a block 310. Afterwards, another query is made, namely, are the credentials verified at a diamond 314. If “no”, then the operation may return to the block 310. If “yes”, the operation can proceed to a further query, namely, are the user selected credentials saved at a diamond 322. If “yes”, the operation can proceed to store a cookie in the browser at a block 326, and then may proceed to refresh the universal shopping cart at the block 306. If “no”, then the operation typically proceeds directly to the block 306 to refresh the universal shopping cart, and afterwards to point “B”.

Generally, when a user launches their browser, the browser can check for a cookie saved in the browser from the online mall website. If such a cookie is found, the browser generally logs the user into the online mall website with the cookie, removes the “just installed” cookie, and waits and observes user activity. Once logged in, the user can be forwarded to the online mall home page as depicted in FIG. 3. Once the home page is loaded, the system usually enables the sidebar in shopping mode, requests the server for user profile data and universal shopping cart data, and loads the merchant website banner and current shopping panel and shopping summary.

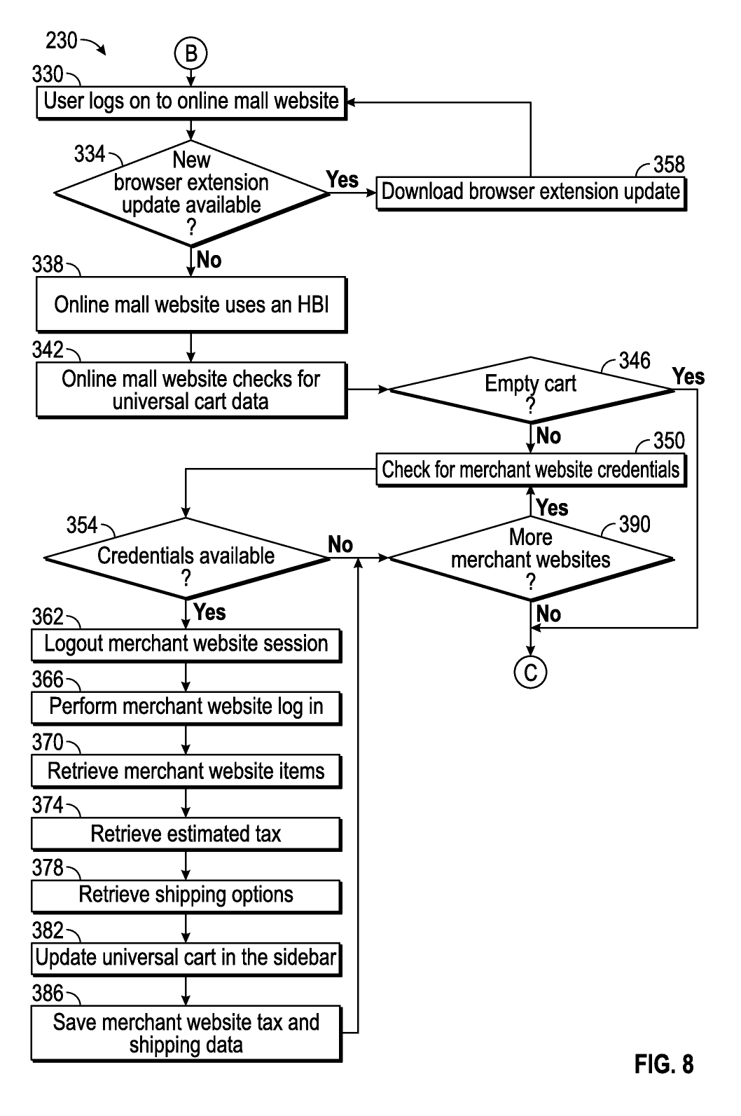

Referring to FIG. 8, after point “B”, a user can log on to the online mall website after registration at a block 330, then can proceed to another query, namely, whether a new browser extension update is available at a diamond 334. If “yes”, the operation usually returns to the block 330 after downloading the browser extension update at a block 358. Generally, the user has to log in if the browser does not remember the previous session.

If “no”, the online mall website can use an HBI at a block 338. Although the process may proceed without knowledge of the user via an HBI session, the user may proceed with multiple visible options to the user, such as adding preferred merchants, seeking help, and contacting administrators. Thus, the HBI may operate in the background while other actions may be undertaken in a screen visible to the user. Afterwards, the online mall website may check for the universal shopping cart data, such as previously selected products for purchase, at a block 342. Next, a query is made as to whether the cart is empty at a diamond 346. Thus, the online mall website can show the option to the user to restore the shopping from a previous session or create a new empty cart. If “yes”, the operation proceeds to point “C” by removing all the previous purchased items and now zero items from zero stores in the sidebar depicted to the user and can create a new empty cart. If “no”, the operation can check for merchant credentials at a block 350. The HBI can be generated and update the universal cart, as hereinafter described. Hence, multiple steps can be undertaken simultaneously. Afterwards, the process may proceed to another query if credentials are available at a diamond 354. If “no”, the operation can proceed to another query at a diamond 390, as hereinafter described. If “yes”, the operation may proceed to log out the merchant session at a block 362 and then perform a merchant log in at a block 366. Next, merchant products can be retrieved at a block 370, estimated tax retrieved at a block 374, shipping options retrieved at a block 378, universal shopping cart in the sidebar can be updated with, e.g., up to five hidden browser instances at a block 382, and tax and shipping data can be saved at a block 386. That being done, the query can be made if more merchant credentials are to be retrieved at a diamond 390. If “yes”, the operation can be repeated at a block 350. If “no”, the operation can proceed to point “C”.

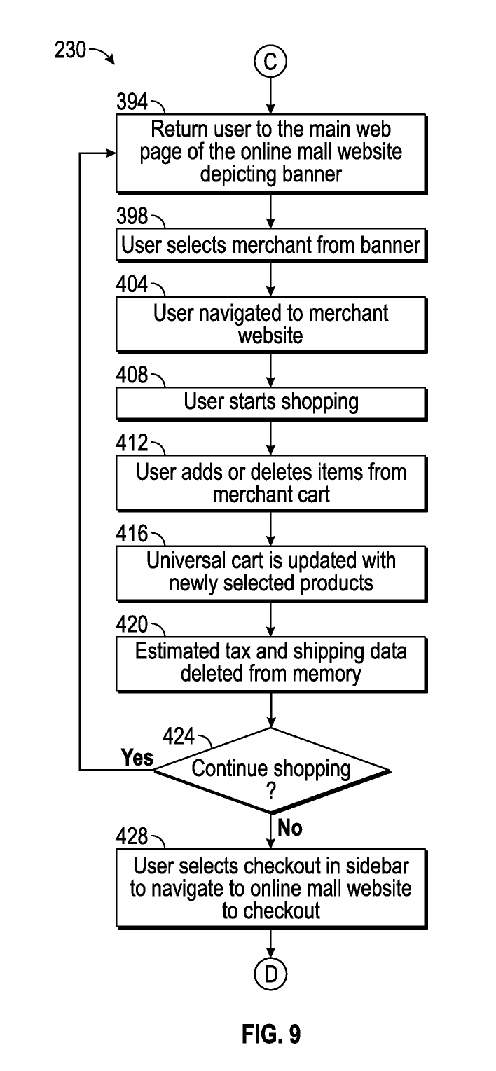

Referring to FIG. 9, from point “C” the user may be returned to the main web page of the online mall website at a block 394. The main web page can feature a banner of merchant websites with links to each merchant's website. Two or more categories may be presented, such as my stores and all stores. Next, the user can select a merchant from the banner at a block 398 and navigate to a merchant website at a block 404. The browser program can retrieve store specification details from the online mall website, and use one of the HBIs for navigating and logging into the online mall website. The merchant website cart can be read with a hidden browser instance and the universal cart updated. This update can proceed in the background and not be visible to the user.

Typically, the user starts shopping at a block 408 and adds and optionally deletes products from the merchant cart at a block 412. The browser program uses one of the HBIs to read the latest merchant cart and update the universal cart. As an aside, credentials may be provided by the browser program if stored at the server of the online mall website and the user logged into the merchant website. In any event, the browser program may read the cart details of the merchant site and update the online mall universal cart. Upon navigating to the linked merchant, a sidebar can be loaded having the universal shopping cart for viewing by the user. The universal shopping cart depicted in the sidebar may be updated with newly selected products, or have selected products deleted, at a block 416. HBIs can update the server at the online mall website as well as the universal shopping cart. Afterwards, the estimated tax and shipping data may be deleted from memory at a block 420, and thereafter proceed to a query whether to continue shopping at a diamond 424. If “yes”, the operation returns to the main web page of the online mall website at the block 394. If “no”, the user may select to checkout in the sidebar and navigate to the online mall website to checkout at a block 428 and then to a point “D”. The browser program communicates with the online mall website to confirm if the profile details are available with the server of the online mall website, which are required to make a purchase. If not, the user can input profile information, shipping information, billing information, and security information. Additionally, if internet connection speed is slow, the browser program may send a message to a user.

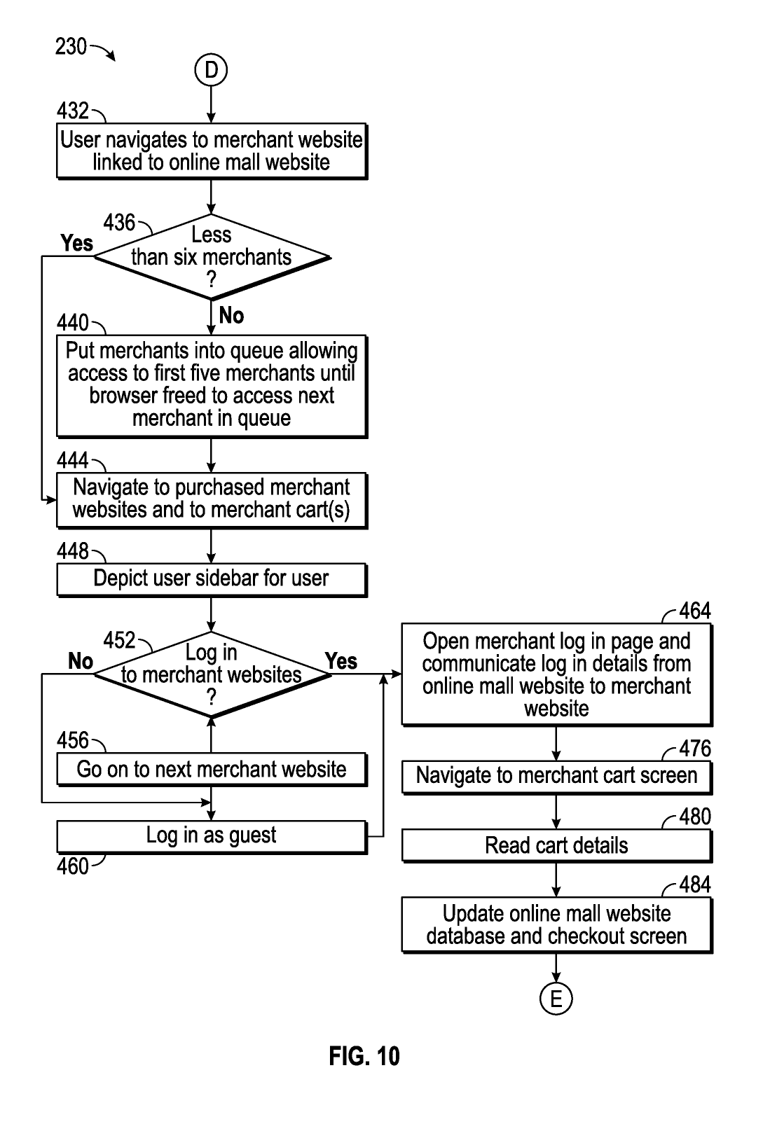

Referring to FIG. 10, at a point “D”, the user can navigate to a merchant website linked to an online mall website at a block 432. In one exemplary embodiment, a web page at the online mall website can depict where the user made purchases. A list of those items can be presented along with the quantity and cost of the items, and a summary of purchases. For each merchant store, links can be provided to the merchant store for modifications in the cart at the merchant site.

The browser program can use up to five HBIs to update the universal cart details and retrieve details such as shipping options and estimated tax details. Often, the browser program can query if there are more merchant sites shopped at by the user. The browser program may also check if there are more than five stores depicted at the webpage and having products in the universal cart, then the browser program chooses five merchant stores and uses five HBIs for performing the following actions. Generally, the browser program may retrieve the store specification details from the online mall website, and use one of the HBIs and navigate to the merchant website log in page. The browser program may also query if the online mall website has the merchant website credentials. Desirably, the browser program may communicate with the online mall website and retrieve the user credentials for that merchant store. The browser program using an HBI may enter the user credentials at and confirm the successful log in to the merchant website. Usually, the browser program launches an HBI to navigate to the merchant website cart screen, read the cart details, and update the online mall universal cart. The browser program utilizes an HBI to communicate with the online mall website and get the default user profile details. An HBI launched by the browser program may update the merchant website with required details and read the shipping options, estimated tax and discount details, and display them to the user on, e.g., a monitor.

Afterwards, a query can be made as to whether there are less than six merchants having products selected by a user at a diamond 436. If “no”, the merchants having products selected can be put into a queue allowing access to the first five merchant websites in the queue until an HBI is freed for the next merchant in the queue at a block 440. Thus, the first five merchant websites can be accessed in parallel. Afterwards, the operation may proceed to a block 444. Although five HBIs are depicted, any suitable number of HBIs may be used, such as more than five HBIs. If the query at the diamond 436 is “yes”, the operation may navigate to the merchant websites with purchased products and corresponding merchant virtual carts at a block 444. That being done, the operation may proceed to depict the user sidebar at a block 448 and then to a query to log in to the merchant websites at a diamond 452. If “no”, the operation can log in as a guest at a block 460 or go on to the next merchant website at a block 456 and return to the query at the diamond 452. If the query at the diamond 452 is “yes”, or log in occurs as a guest, the operation can proceed to open the merchant log in page and communicate the log in details from the online mall website to the merchant website at a block 464. Next, the user navigates to a merchant cart screen at a block 476. Afterwards, the cart details generally are read by the system at a block 480 and the online mall website database and sidebar are updated at a block 484 before moving to point “E”.

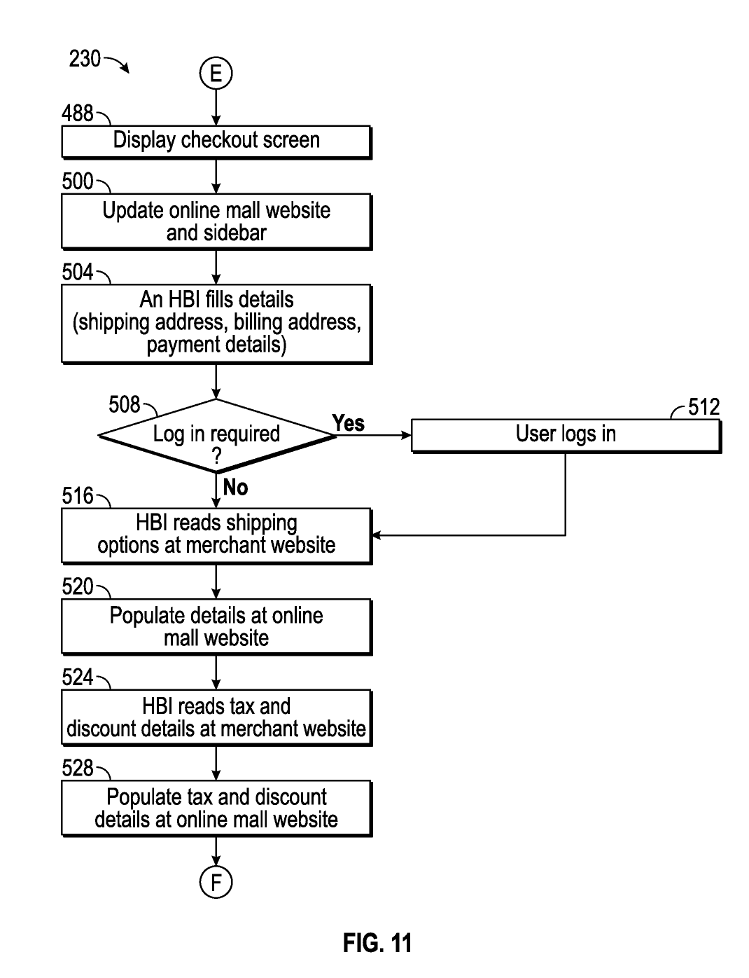

Referring to FIG. 11, after point “E”, the checkout screen may be displayed if the user selects the “Proceed to Checkout” button in the sidebar at a block 488. The checkout screen can include the name, quantity, and price of the product as well as the total products purchased and merchandise total, as depicted in FIG. 5. Often, the sidebar can be updated with information from the merchant website at a block 500. The information obtained from the merchant website can include estimated tax, shipping options, shipping charges, and estimated total order from that merchant. Subsequently, one or more HBIs usually fills in details regarding the purchase transaction, such as shipping address, billing address, and payment details at a block 504. In this exemplary embodiment, five HBIs can be used in parallel, and yet in other embodiments any number of HBIs may be used, such as more than five. That being done, a query as to whether a log on is required at a diamond 508 may be made. If “yes”, the user generally logs in at a block 512 and proceeds to a block 516. If “no”, an HBI may read shipping options at the merchant website at the block 516 and proceed to populate details at the online mall website at a block 520. Afterwards, an HBI can read tax and discount details at the merchant website at a block 524 and then proceed to populate tax and discount details at the online mall website at a block 528. Subsequently, the operation may proceed to a point “F”.

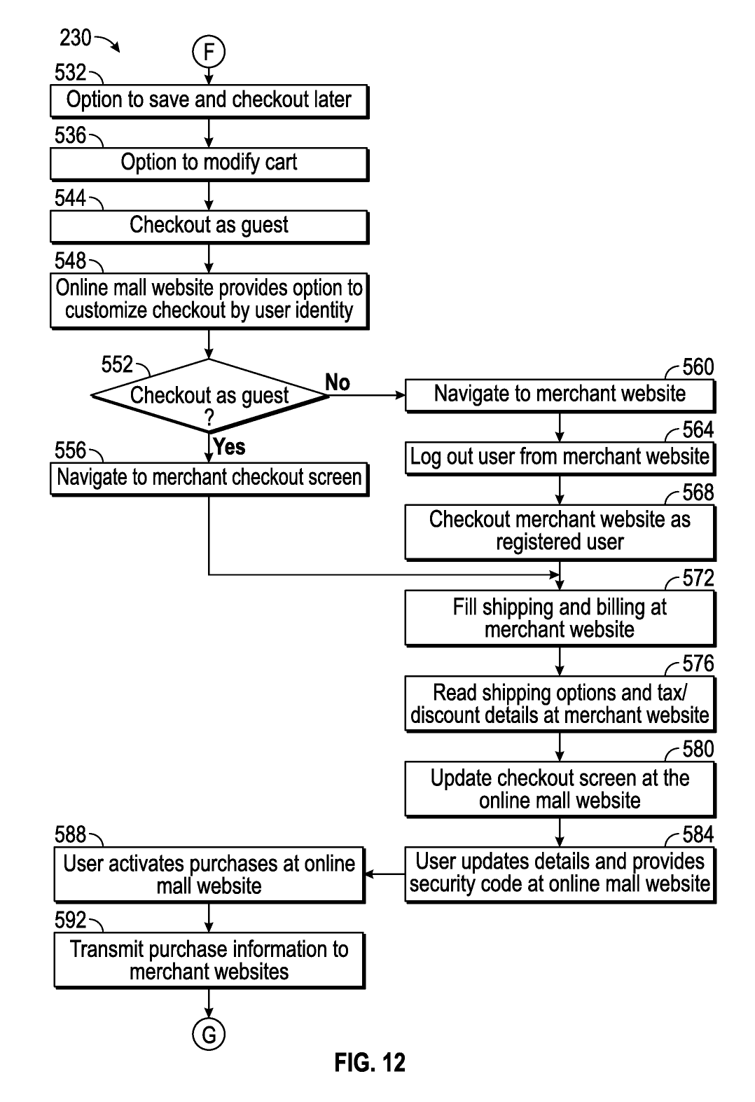

Referring to FIG. 12, after point “F”, an option can be provided to save and checkout later at a block 532 and an option to modify the cart at a block 536. Next, an option to checkout as a guest may be provided at a block 544 and the online mall website can provide an option to customize checkout by user identity at a block 548. Although depicted sequentially, it should be understood that the steps at the blocks 532, 536, and 544 can be conducted in parallel or omitted altogether. Subsequently, the system offers a query whether to checkout as a guest at a diamond 552. If “yes”, the operation can navigate to a merchant checkout screen at a block 556 and then to a block 572. If the query at the diamond 552 is “no”, then the operation can navigate to a merchant website usually with an HBI at a block 560 before proceeding to log out a user from a merchant website at a block 564. Subsequently, checkout as a registered user can proceed at a merchant website, which is not required for guest checkout, using an HBI at a block 568, and then the shipping and billing fields can be filled at the merchant website with a hidden browser instance at a block 572. Next, shipping options, and tax and discount details can be read at the merchant website at a block 576 and update the checkout screen at the online mall website with a hidden browser instance at a block 580. Afterwards, the user may update details and provide a security code at the online mall website at a block 584, or the user may activate purchases at the online mall website by selecting a button, such as “Place Order Now” at a block 588.

During activating purchases or checkout, the online mall website depicts the cart screen with the merchant store name and the products with price details and estimated tax details obtained from the corresponding merchant website. Once the user places an order or checks out, the online mall website depicts the checkout status screen and the browser program performs the following actions. The browser program reads all the options selected by the user and saves them in the local memory. The browser program checks the total number of stores from which checkout needs to be done excluding the merchant stores marked as saved and to be checked out later. The browser program uses five HBIs to perform the checkout by randomly choosing the first five stores. After completing a checkout, any freed HBI browser takes the next merchant store from the remaining merchant stores and performs checkout. The browser program uses one HBI for each merchant store for performing the checkout and navigates to the merchant site cart screen, and fills all the details like shipping address, billing address, payment method, shipping options and completes the order processing at the merchant website. Subsequently, purchase information can be transmitted to the corresponding merchant websites with corresponding HBIs at a block 592 before proceeding to point “G”.

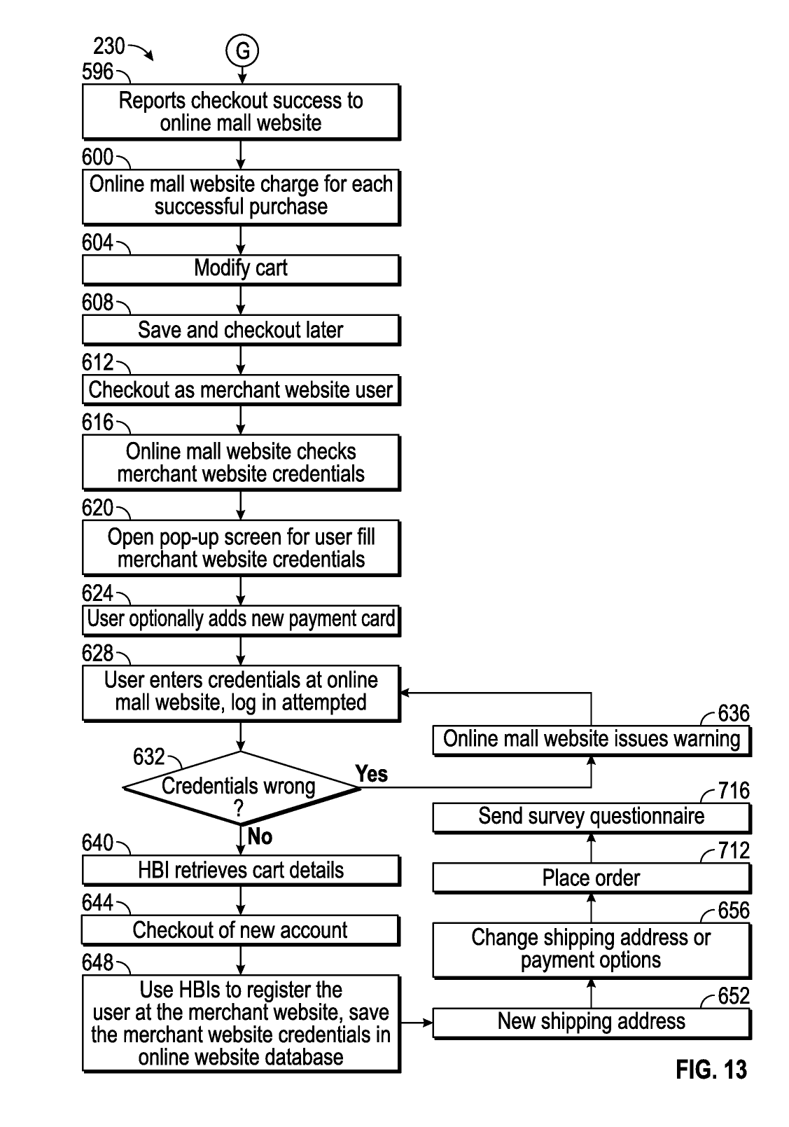

Referring to FIG. 13, after point “G”, the operation may proceed to reporting checkout success at the online mall website at a block 596 prior to proceeding to charge for each successful purchase at a block 600. When filling in the details at the merchant website, the browser program updates the user screen with the status as completed. While completing the checkout process, if there are any error messages shown at the merchant site, the browser program shows the message to the user on their display. After completing all the actions in the checkout process, the browser program reads the order confirmation number form from the merchant site and updates the online mall website.

Next, several optional steps may be performed. An option to modify the cart may be provided at a block 604 and another option to save and checkout later can be provided at a block 608. The online mall website can also show a link to modify the cart corresponding to each store. Clicking on this link navigates the user to the merchant website cart screen. The user can click the sidebar options to navigate back to the online mall website, and optionally save the session for subsequent checkout later. If this option is selected and purchases are made, this merchant store will not be included for processing by the browser program. Furthermore, the merchant website depicts the details of changes and provides options to the user to select the payment option (credit card). When the order is placed, the online mall uses this payment option to get the charges.

Subsequently, a further option to checkout as a merchant user is provided at a block 612, and then the online mall website may check for merchant credentials at a block 616. If the user selects the option to checkout as a store user, the browser program can retrieve the merchant credentials from the online mall website and use them to checkout. Afterwards, a pop-up screen may appear for filling in user merchant credentials at a block 620 and the user may optionally add a new payment card at a block 624. Additionally, the online mall website depicts the user billing profile details for selecting the credit card to be used for checkout. Next, the user may enter credentials at the online mall website to attempt a log in at a block 628 before proceeding to a query as to whether the credentials are wrong at a diamond 632. If the merchant credential details are not available for checking out, a screen can request the user to enter the merchant store credentials and merchant credit card details. The browser program can verify the details with the merchant website, and if valid, save the details in the online mall website. If “yes”, the online mall website can issue a warning at a block 636 before returning to the block 628. Incidentally, if any errors occur during registration, the browser program may show the error message to the user. If “no”, then an HBI can retrieve cart details at a block 640 before proceeding to checkout of a new account at a block 644. If the user selects the option to create a new account, the browser program may use one of the HBIs to navigate to the merchant site registration page, communicate with the online mall website to get the user profile information and perform the registration on the merchant site. Afterwards, the user credentials of that merchant can be saved on the server of the online mall website for future purchases. Next, options are provided for a new payment card at a block 648 and a new shipping address at a block 652. Subsequently, the operation can proceed to change the shipping address or payment options at a block 656. Moreover, the online mall website shows the user shipping profile details for selecting the shipping address for the checkout. Additionally, the browser program uses one of the HBIs to navigate to the merchant store cart screen, reads the shipping options, and shows the details to the user. When the user changes any of the options for checkout, payment, shipping address and shipping options, typically the browser program uses one of the HBIs to navigate to the merchant website and using the options selected by the user as the checkout, payment, shipping address, and/or shipping options, fills the merchant website checkout screens, reads the estimated taxes and discount details, and shows this information to the user on the online mall website screen.

An order is placed at a block 712 before sending a survey to a user at a block 716. If no further initiation by the user, the mode of operation can cease. Once the system completes its process, the merchant websites process the payments and ship the purchased goods to the user. The system is designed to replicate the actions of a consumer so the merchant websites may not be aware that products were purchased via the online mall website.

Although many of these steps in FIG. 13 are shown sequentially, it should be understood that many of these steps can be performed independently. As an example, anytime the user logs into the system but does not access the system for more than a specified time, the user is required to log in again as the system checks idle time and logs the user out. In some exemplary embodiments the steps 604-656 can be performed before the step at the block 588 and, as an example, after the step at the block 584.

It is understood that the methods and systems described above may contain software and hardware connected to the internet via a network. Computing devices used to implement the systems and methods described herein are capable of communicating with each other via the internet, and it should be appreciated that the various functionalities of the components may be implemented on any number of devices.

Although internal components of the computer are not shown, those of ordinary skill in the art will appreciate that such components and the interconnections are well known. Accordingly, additional details concerning the internal construction of the computer need not be disclosed in connection with the present invention.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

1. A method for facilitating online commerce, comprising:
navigating to an online mall website comprising a database;
entering user data into the database;
navigating to a merchant website of a plurality of merchant websites without cooperation from the plurality of merchant websites;
viewing the merchant website with a browser instance; and
opening a plurality of hidden browser instances to communicate information to and from the online mall website and the merchant website offering products for sale.

2. The method according to claim 1, wherein the information communicated from the merchant website to the online mall website comprises product information selected by the user.

3. The method according to claim 1, wherein the information communicated from the online mall website to the merchant website is credentials for logging into the merchant website.

4. The method according to claim 1, further comprising generating a sidebar featuring a universal shopping cart at the merchant website.

5. The method according to claim 4, further comprising loading information about a product selected by the user into a hidden browser instance and communicating the product information to the database and updating the universal shopping cart with the product information.

6. The method according to claim 1, further comprising maintaining integration to update an inventory of a universal shopping cart and each merchant shopping cart.

7. The method according to claim 6, further comprising maintaining integration for sending product information as to shipping options and tax to the database.

8. The method according to claim 1, further comprising downloading an extension from the online mall website to modify the browser for generating the plurality of hidden browser instances to facilitate communication between the online mall website and the plurality of merchant websites in parallel.

9. The method according to claim 1, wherein the plurality of hidden browser instances operates in a background and is not visible to the user.

10. The method according to claim 1, further comprising creating a hidden browser instance queue of up to five hidden browser instances for communicating with the plurality of merchant websites in parallel.

11. A system for online commerce, the system comprising:
a data processing device that is adapted to execute computer-readable instructions contained in a memory;
wherein the data processing device is structured and arranged to provide a browser to a merchant website of a plurality of merchant websites at which a user can navigate to and through, provide at least one of a web page that is separate from the merchant website and a web page provided at the merchant website, display purchase and product information extracted from the merchant website, provide a universal shopping cart at the merchant website that is separate from a merchant shopping cart, store at least one product offered for sale at the merchant website, transact a single checkout transaction with the user, and maintain integration between an online mall website and the plurality of merchant websites by generating a plurality of hidden browser instances to communicate with the plurality of merchant websites.

12. The system according to claim 11, wherein the data processing device is further adapted to maintain an integration with a discrete, merchant shopping cart for each merchant having at least one product contained in the universal shopping cart.

13. The system according to claim 12, wherein the integration is maintained by generating up to five hidden browser instances to communicate with up to five respective merchant websites.

14. The system according to claim 11, wherein the universal shopping cart in the online mall website provides an inventory of products that have been added at any time to any of the merchant shopping carts.

15. The system according to claim 11, wherein each of the at least one product is identified and searchable on any merchant's website using at least one of a uniform resource locator and a universal product identification number.

16. The system according to claim 11, wherein the online mall website further comprises a server, which in turn comprises a database for providing an extension to modify a browser for providing the plurality of hidden browser instances.

17. The system according to claim 11, further comprising a browser that maintains integration with discrete merchants; transacts the single checkout transaction with the user; and in response to instructions from the user, completes a purchase transaction with each discrete merchant by utilizing the plurality of the hidden browser instances.

18. The system according to claim 17, wherein the browser is adapted to transfer information between the online mall website and the plurality of merchant websites by launching up to five hidden browser instances.

19. The system according to claim 18, wherein the hidden browser instances are not visible to a user.

20. An article of manufacture for completing a single checkout purchase transaction between an online user and a plurality of merchants, the article of manufacture comprising a computer-readable program embedded thereon for completing the single checkout purchase transaction, the program comprising instructions for:
providing an online mall website at which a user can navigate to and through at least one web page that displays purchase and product information extracted from any of the plurality of merchants without cooperation from the plurality of merchants;
providing a universal shopping cart on at least one merchant website for storing and managing without cooperation from any of the plurality of merchants at least one product offered for sale by any of the plurality of merchants;
generating a plurality of hidden browser instances to establish communication between the online mall website and a plurality of merchant websites; and
providing real time product information until a transaction session is completed.
